(19) United States
(12) Patent Application Publication
(10) Pub. No.: US 2012/0056753 A1
(43) Pub. Date: Mar. 8, 2012

(54) METER AND COMMUNICATION RELAY METHOD

(75) Inventors: WEN-ZHONG CHEN, Shanghai (CN); SHU-SHU HU, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/008,827

(22) Filed: Jan. 18, 2011

(30) Foreign Application Priority Data
Sep. 8, 2010 (CN) 201010275534.7

(51) Int. Cl. G08C 15/06

(52) U.S. Cl. 340/870.02

(57) ABSTRACT

A meter receives a new communication frame from a power line, and determines whether the new communication frame is used to read power consumption of the meter. If the new communication frame is used to read power consumption of the meter, the meter generates a response frame of the new communication frame, and broadcasts the response frame to the concentrator via the power line to report the power consumption of the meter. If the new communication frame is not used to read power consumption of the meter, the meter broadcasts the new communication frame to the at least one other meter and the concentrator via the power line.

### BACKGROUND

1. Technical Field

The present disclosure relates to a meter reading system, and more particularly to a meter and a communication relay method.

2. Description of Related Art

An electricity meter or a power meter is a device that measures the amount of electrical energy consumed by a residence, business, or an electrically powered device. With the development of power line communications, the technology of automatically reading the electric meter via a power line is now in widespread use.

However, the technology of automatically reading the electricity meter via the power line needs a communication relay method to report power consumption of the electric meter to a concentrator. It becomes a big challenge to develop a stable and smart communication relay method with a long communication distance.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of one embodiment of a meter reading system including a concentrator and a plurality of meters;

FIG. 2 is a schematic diagram of one embodiment of a communication frame used by the meter in accordance with the present disclosure;

FIG. 3 is a schematic diagram of one embodiment of a network topology of the meter in accordance with the present disclosure;

FIG. 4 is a schematic diagram of another embodiment of the network topology of the meter in accordance with the present disclosure;

FIG. 5 is a schematic diagram of a further embodiment of the network topology of the meter in accordance with the present disclosure;

FIG. 6 is a schematic diagram of functional modules of one embodiment of the meter in accordance with the present disclosure;

FIG. 7 is a flowchart of one embodiment of a communication relay method in accordance with the present disclosure;

FIG. 8 is a detailed flowchart of step S110 of the communication relay method of FIG. 7; and

FIG. 9 is a detailed flowchart of step S112 of the communication relay method of FIG. 7.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

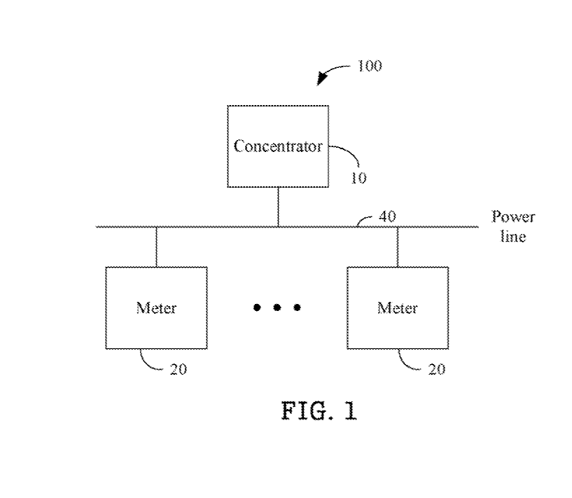

FIG. 1 is a schematic diagram of an application environment of one embodiment of a meter reading system 100 including a concentrator 10 and a plurality of meters 20. Each of the meters 20 may be an electricity meter or a power meter, which is a device that measures the amount of electrical energy consumed by a residence, business, or an electrically powered device. The concentrator 10 is connected to the plurality of meters 20 via a power line 40. The concentrator 10 broadcasts a plurality of request frames to the plurality of meters 20 via the power line 40 to read power consumption of the meters 20. The meters 20 broadcast a plurality of response frames of the request frames to the concentrator 10 via the power line 40 to report power consumption of the meters 20. It should be understood that amount of electricity used directly correlates to power consumption, thus the present disclosure may sometimes refer to electricity and power as being separate items or the same item.

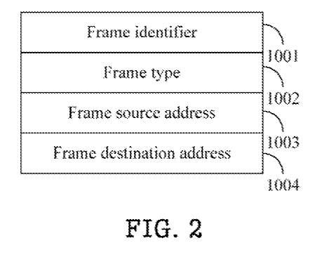

The request frames and the response frames are both called communication frames. Referring to FIG. 2, each of the communication frames includes a frame identifier 1001, a frame type 1002, a frame source address 1003, and a frame destination address 1004. The frame identifier 1001 identifies each communication frame. The frame type 1002 indicates a type of each communication frame 1000 is a request frame or a response frame. The frame source address 1003 indicates an address of a device generating each communication frame, and the frame destination address 1004 indicates an address of a destination device of each communication frame. Details of frame addresses are discussed below.

Each communication frame and a response frame of each communication frame have the same frame identifier 1001. Frames types 1002 of each communication frame and the response frame of each communication frame are respectively a request frame and a response frame. The frame source address 1003 and the frame destination address 1004 of each communication frame are respectively the same as the frame destination address 1004 and the frame source address 1003 of the response frame of the communication frame.

In one example, it is assumed that an address of the concentrator 10 is 0×100, an address of one of the meters 20 is 0×110, a type of a request frame is 0×001, a type of a response frame is 0×000, and a current frame identifier is 0×111. In such instance, a request frame from the concentrator 10 to the one of the meters 20 includes a frame identifier of 0×111, a frame type of 0×001, a frame source address of 0×100, and a frame destination address of 0×110. Accordingly, the response frame of the request frame, from the one of the meters 20 to the concentrator 10, includes a frame identifier of 0×111, a frame type of 0×000, a frame source address of 0×110, and a frame destination address of 0×100.

In one embodiment, the meter reading system 100 reads power consumption of the meters 20 by a random relay means. In detail, the request frames are broadcasted from the concentrator 10 to the meters 20 via the power line 40 by the random relay means, and the response frames are broadcasted from the meters 20 to the concentrator 10 via the power line 40 by the random relay means.

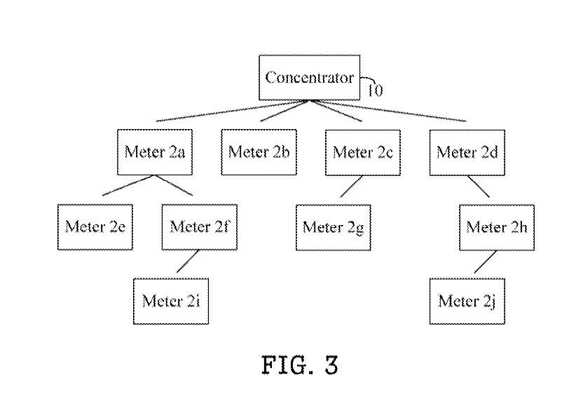

For example, referring to FIG. 3, meters 2a-2j are assumed to be part of the meters 20 of FIG. 1. If the concentrator 10 wants to read the meter 2i, the concentrator 10 broadcasts a request frame to the power line 40 to read the meter 2i. The meters 2a, 2b, 2c, 2d first and directly receive the request frame from the concentrator 10 because the meters 2a, 2b, 2c, 2d are closer to the concentrator 10, or the power line 40 between the meters 2a, 2b, 2c, 2d and the concentrator 10 has a good power line communication status. However, the meters 2e, 2f, 2g, 2h, 2i, 2j do not first and directly receive the request frame from the concentrator 10 because the meters 2e, 2f, 2g, 2h, 2i, 2j are farther from the concentrator 10 or the power line 40 between the meters 2a, 2b, 2c, 2d and the concentrator 10 has a bad power line communication status.

Each of the meters 2a, 2b, 2c, 2d determines whether the request frame is used to read itself after the meters 2a, 2b, 2c, 2d receives the request frame. Each of the meters 2a, 2b, 2c, 2d further broadcasts the request frame to the power line 40 because the request frame is used to read the meter 2i instead of the meters 2a, 2b, 2c, 2d.

The meters 2a, 2b, 2c, 2d may receive the request frame again because of the random relay means. In such a case, the meters 2a, 2b, 2c, 2d ignore the request frame received again, so that the random relay means is executed orderly.

Then, the meters 2e, 2f first and directly receives the request frame from the meter 2a because the meters 2e, 2f are closer to the meter 2a or the power line 40 between the meters 2e, 2f and the meter 2a has a good power line communication status.

Each of the meters 2e, 2f determines whether the request frame is used to read itself after the meters 2e, 2f receive the request frame. Each of the meters 2e, 2f further broadcasts the request frame to the power line 40 because the request frame is used to read the meter 2i instead of the meters 2e, 2f.

The meters 2e, 2f may receive the request frame again because of the random relay means. In such a case, the meters 2e, 2f ignores the request frame received again, so that the random relay means is executed orderly.

The meter 2i first and directly receives the request frame from the meter 2f because the meter 2i is closer to the meter 2f or the power line 40 between the meter 2i and the meter 2f has a good power line communication status. The meter 2i determines whether the request frame is used to read itself after the meter 2i receives the request frame. The meter 2i broadcasts a response frame of the request frame to the power line 40 because the request frame is used to read the meter 2i.

Similarly to the random relay means of the request frame, the response frame of the request frame is transmitted from the meter 2i to the concentrator 10 via part or all of the meters 2a-2j. For example, if the power line 40 between the meter 2i and the concentrator 10 has an excellent power line communication status, the response frame of the request frame may be first and directly broadcasted from the meter 2i to the concentrator 10. If the power line 40 between the meter 2i and the concentrator 10 has a normal power line communication status, the response frame of the request frame may be indirectly broadcasted from the meter 2i to the concentrator 10 via the meters 2f, 2a.

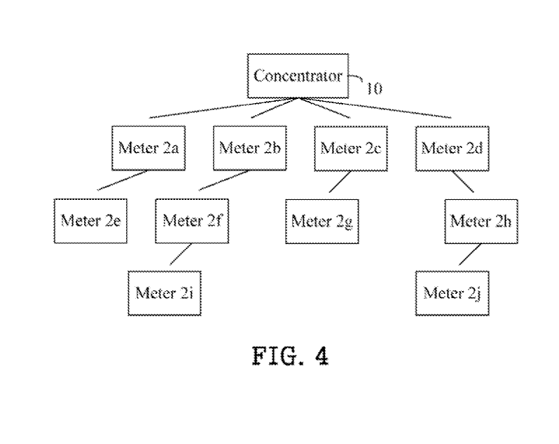

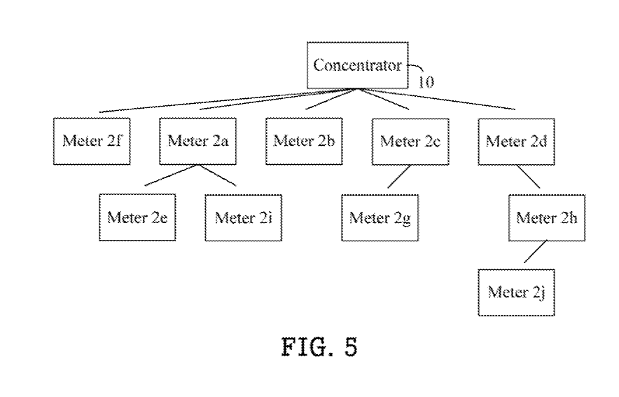

It should be noted that the network topology of FIG. 3 may be changed along the power line communication status of the power line 40. For instance, referring to FIG. 4, assuming that the power line communication status between the meter 2a and the meter 2f becomes worse, and the power line communication status between the meter 2b and the meter 2f becomes better, the meter 2f may first and directly receive the request frame broadcasted by the meter 2b. Further referring to FIG. 5, assuming the power line communication status between the meter 2f and the concentrator 10 becomes relatively better, the meter 2f may first and directly receive the request frame broadcasted by the concentrator 10.

Due to the random relay means the meter reading system 100 is not only intelligent and stable, but also has a long communication distance.

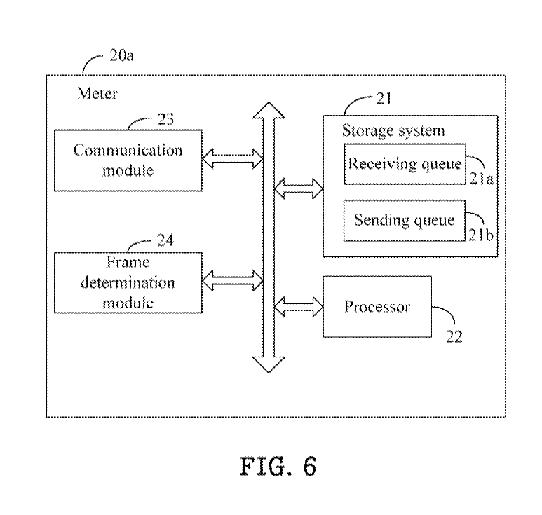

FIG. 6 is a schematic diagram of functional modules of one embodiment of a meter 20a in accordance with the present disclosure. In one embodiment, the meter 20a is one of the meters 20 of FIG. 1, and includes a storage system 21, at least one processor 22, a communication module 23, and a frame determination module 24. The modules 23-24 may comprise computerized code in the form of one or more programs that are stored in the storage system 21. The computerized code includes instructions that are executed by the at least one processor 22 to provide functions for the modules 23-24. The storage system 21 may be ROM or a cache system, for example.

The storage system 21 stores a receiving queue 21a and a sending queue 21b. The receiving queue 21a is operable to record communication frames received by the meter 21a, and the sending queue 21b is operable to record communication frames sent by the meter 21a.

The communication module 23 is operable to receive a new communication frame from the power line 40. In one embodiment, the new communication frame is one of the request frames broadcasted by the concentrator 10 and the response frames broadcasted by the meter 20a or the other meters 20.

The frame determination module 24 is operable to determine whether a frame the same as the new communication frame is found in the receiving queue 21a, adds the new communication to the receiving queue 21a when no frame the same as the new communication frame is found in the receiving queue 21a. The frame determination module 24 ignores the new communication frame when a frame the same as the new communication frame is found in the receiving queue 21a, so that the random relay means is executed orderly.

The frame determination module 24 is further operable to determine whether the new communication frame is used to read power consumption of the meter 20a. In one embodiment, the frame determination module 24 determines whether a frame destination address of the new communication frame is an address of the meter 20a so as to check whether the new communication frame is used to read power consumption of the meter 20a. If the frame destination address of the new communication frame is the address of the meter 20a, the frame determination module 24 determines that the new communication frame is used to read power consumption of the meter 20a. If the frame destination address of the new communication frame is not the address of the meter 20a, the frame determination module 24 determines that the new communication frame is not used to read power consumption of the meter 20a.

The communication module 23 is further operable to generate a response frame of the new communication frame and broadcast the response frame of the new communication frame to the concentrator 10 to report the power consumption of the meter 20a upon the condition that the new communication frame is used to read power consumption of the meter 20a. In one embodiment, the communication module 23 waits a first back-off time according to a collision back-off algorithm until a channel of the power line 40 is idle, and broadcasts the response frame of the new communication frame to the concentrator 10 by the channel of the power line 40.

The communication module 23 is further operable to broadcast the new communication frame to the concentrator 10 and the other meters 20 via the power line 40 when the new communication frame is not used to read power consumption of the meter 20a.

In one embodiment, the frame determination module 24 further determines whether a type of the new communication frame is a request frame. If the frame type of the new communication frame is not a request frame, the communication module 23 waits a second back-off time according to the collision back-off algorithm until the channel of the power line 40 is idle, and broadcasts the new communication frame to the concentrator 10 by the channel of the power line 40.

If the frame type of the new communication frame is a request frame, the communication module 23 further determines whether a response frame of the new communication frame is found in the receiving queue 21a. If the response frame of the new communication frame is not found in the receiving queue 21a, the communication module 23 waits a third back-off time according to the collision back-off algorithm until the channel of the power line 40 is idle, and broadcasts the new communication frame to the other meters 20 by the channel of the power line 40. If the response frame of the new communication frame is found in the receiving queue 21a, the communication module 23 ignores the new communication frame, in order that the random relay means is executed orderly.

In one embodiment, the collision back-off algorithm is described as follows: first waiting r*2T seconds before sending a communication frame (a request frame or a response frame), then detecting the channel of the power line 40 is idle, broadcasting the communication frame if the channel of the power line 40 is idle, otherwise further waiting another r*2T seconds. The r indicates a random number generated based on the address of the meter 20a. The 2r is a collision time slot, which is a return propagation delay of the channel of the power line 40, and is also the time required for the meter 20a to detect collision with certainty.

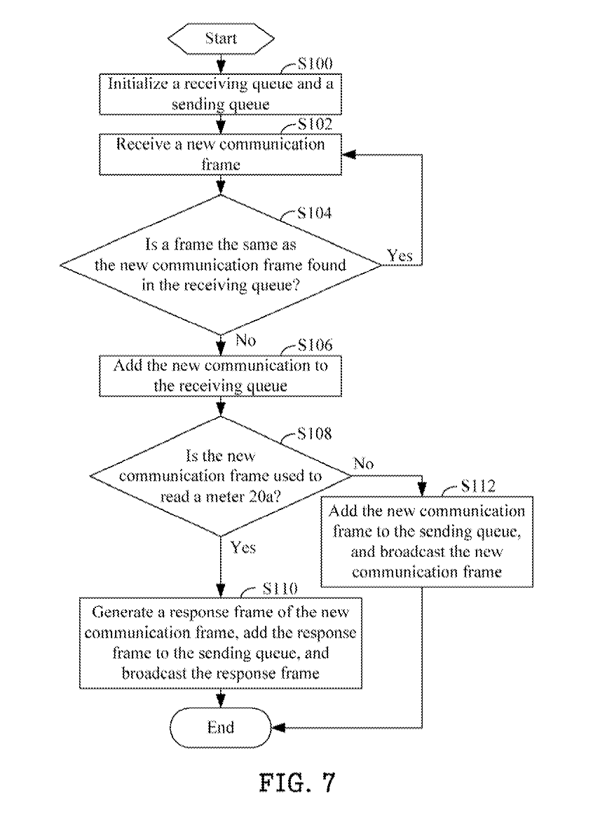

FIG. 7 is a flowchart of one embodiment of a communication relay method in accordance with the present disclosure. The method may be embodied in the meter 20a, and is executed by the functional modules such as those of FIG. 6. Depending on the embodiment, additional blocks may be added, others deleted, and the ordering of the blocks may be changed while remaining well within the scope of the disclosure.

In bock S100, the storage module 21 initializes the receiving queue 21a and the sending queue 21b.

In block S102, the communication module 23 receives a new communication frame from the power line 40. The new communication frame may be a request frame or a response frame.

In block S104, the frame determination module 24 determines whether a frame the same as the new communication frame is found in the receiving queue 21a.

If a frame the same as the new communication frame is found in the receiving queue 21a, the communication module 23 ignores the new communication frame. Going back to block S102, the communication module 23 continues to receive a next new communication frame.

If no frame the same as the new communication frame is found in the receiving queue 21a, in block S106, the storage system 21 adds the new communication frame to the receiving queue 21a.

In block S108, the frame determination module 24 determines whether the new communication frame is used to read power consumption of the meter 21a. In one embodiment, the frame determination module 24 determines whether a frame destination address of the new communication frame is an address of the meter 20a so as to check whether the new communication frame is used to read power consumption of the meter 20a. If the frame destination address of the new communication frame is the address of the meter 20a, the frame determination module 24 determines that the new communication frame is used to read power consumption of the meter 20a. If the frame destination address of the new communication frame is not the address of the meter 20a, the frame determination module 24 determines that the new communication frame is not used to read power consumption of the meter 20a.

If the new communication frame is used to read power consumption of the meter 20a, the communication module 23 generates a response frame of the new communication frame, adds the response frame of the new communication frame to the sending queue 21b, and broadcasts the response frame of the new communication frame to the concentrator 10 via the power line 40 to report the power consumption of the meter 20a.

If the new communication frame is not used to read power consumption of the meter 20a, the communication module 23 adds the new communication frame to the sending queue 21b, and broadcasts the new communication frame to the concentrator 10 and the other meters 20 via the power line 40.

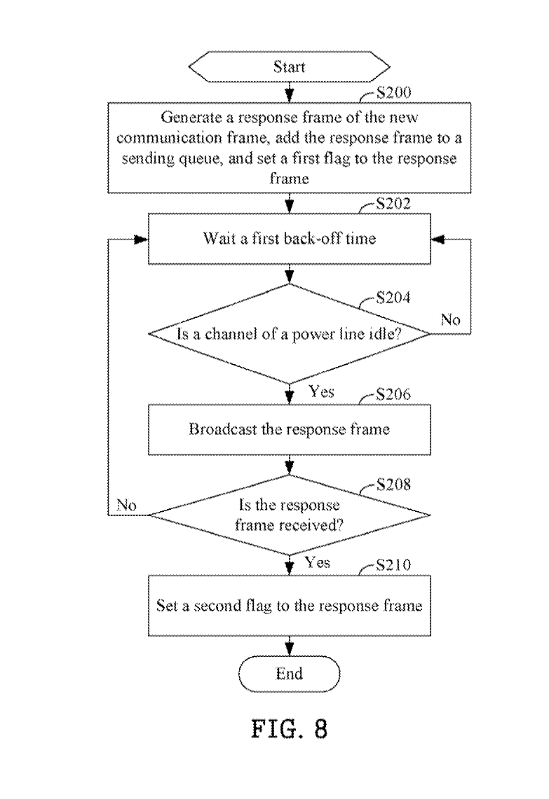

FIG. 8 is a detailed flowchart of step S110 of the communication relay method of FIG. 7. In one embodiment, the communication module 23 is ready to respond the new communication frame from the power line 40.

In block S200, the communication module 23 generates a response frame of the new communication frame, adds the response frame of the new communication frame to the sending queue 21b, and sets a first flag to the response frame of the new communication frame in the sending queue 21b. In one embodiment, the first flag may be 0, which indicates that the response frame of the new communication frame is ready to be sent.

In block S202, the communication module 23 waits a first back-off time according to a collision back-off algorithm.

In block S204, the communication module 23 determines whether a channel of the power line 40 is idle.

If the channel of the power line 40 is idle, in block S206, the communication module 23 broadcasts the response frame of the new communication frame to the concentrator 10 by the channel of the power line 40.

In block S208, the communication module 23 determines whether the response frame of the new communication frame is received.

If the response frame of the new communication frame is received, in block S210, the communication module 23 sets a second flag to the response frame of the new communication frame in the sending queue 21b. In one embodiment, the second flag may be 1, which indicates that the response frame of the new communication frame has been successfully broadcast.

If the response frame of the new communication frame is not received, blocks S202-S208 are repeated until the response frame of the new communication frame has been successfully broadcast.

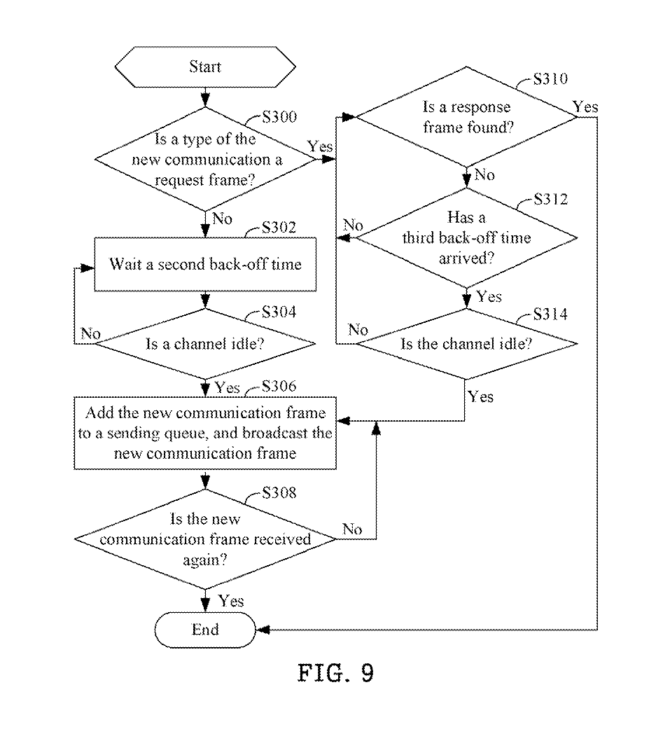

FIG. 9 is a detailed flowchart of step S112 of the communication relay method of FIG. 7. In this embodiment, the communication module 23 is ready to broadcast the new communication frame to the power line 40.

In block S300, the frame determination module 24 determines whether a type of the new communication frame is a request frame.

If the type of the new communication frame is a response frame instead of a request frame, in block S302, the communication module 23 waits a second back-off time according to the collision back-off algorithm.

In block S304, the communication module 23 determines whether the channel of the power line 40 is idle.

If the channel of the power line 40 is idle, the communication module 23 adds the new communication frame to the sending queue 21b, and broadcasts the new communication frame to the concentrator 10 by the channel of the power line 40.

If the type of the new communication frame is a request frame, the frame determination module 24 determines whether a response frame of the new communication frame is found in the receiving queue 21a.

If the response frame of the new communication frame is found in the receiving queue 21a, the communication module 23 ignores the new communication frame, in order that the random relay means is executed orderly.

If the response frame of the new communication frame is not found in the receiving queue 21a, the communication module 23 calculates a third back-off time according to the collision back-off algorithm and determines whether the third back-off time has arrived.

If the third back-off time has not arrived, back to block S310, the frame determination module 24 further determines whether a response frame of the new communication frame is found in the receiving queue 21a.

If the third back-off time has arrived, in block S314, the communication module 23 determines whether the channel of the power line 40 is idle.

If the channel of the power line 40 is idle, in block S306, the communication module 23 adds the new communication frame to the sending queue 21b, and broadcasts the new communication frame to the other meters 20 by the channel of the power line 40.

In block S308, the communication module 23 determines whether the new communication frame is received again.

If the new communication frame is not received again, back to block S306, the communication module 23 broadcasts the new communication frame again until the new communication frame is successfully broadcast.

In one embodiment, the collision back-off algorithm of block S202 in FIG.8, and blocks S302, S312 in FIG. 9 is described as follows: first waiting r*2T seconds before sending a communication frame (a request frame or a response frame), then detecting the channel of the power line 40 is idle, broadcasting the communication frame if the channel of the power line 40 is idle, otherwise further waiting another r*2T seconds.

Thus, the meter reading system 100 and the communication relay method utilize the random relay means to read power consumption of meters 20, 20a, and accordingly the meters 20, 20a utilize the random relay means to report the power consumption of the meters 20, 20a to the concentrator 10. That is, the request frame is broadcasted from the concentrator 10 to the meters 20, 20a via the power line 40, and the response frame is broadcasted from the meters 20, 20a to the concentrator 10 via the power line 40. Thus, the meter reading system 100 and the communication relay method are not only intelligent and stable, but also have a long communication distance.

Additionally, the meter 20, 20a utilizes the collision back-off algorithm to assure the random relay means is executed orderly.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A meter connected to a concentrator and at least one other meter via a power line, the concentrator broadcasting a plurality of request frames to the meter and the at least one other meter via the power line, the meter and the at least one other meter broadcasting a plurality of response frames of the request frames to the concentrator via the power line to read power consumption of the meter and the at least one other meter, the meter comprising:
at least one processor;
a storage system;
one or more programs that are stored in the storage system and are executed by the at least one processor, the one or more programs comprising:
a communication module operable to receive a new communication frame from the power line, wherein the new communication frame is one of the request frames originally broadcasted by the concentrator and the response frames originally broadcasted by the meter and the at least one other meter; and
a frame determination module operable to determine whether the new communication frame is used to read power consumption of the meter;
wherein the communication module further generates a response frame of the new communication frame and broadcasts the response frame of the new communication frame to the concentrator via the power line to report the power consumption of the meter upon the condition that the new communication frame is used to read power consumption of the meter;
wherein the communication module further broadcasts the new communication frame to the concentrator and the at least one other meter via the power line when the new communication frame is not used to read power consumption of the meter.

2. The meter of claim 1, wherein the storage system stores a receiving queue and a sending queue, the receiving queue is operable to record communication frames received by the meter, and the sending queue is operable to record communication frames sent by the meter.

3. The meter of claim 2, wherein the frame determination module further determines whether a frame the same as the new communication frame is found in the receiving queue, adds the new communication frame to the receiving queue when no frame the same as the new communication frame is found in the receiving queue, and ignores the new communication frame when a frame the same as the new communication frame is found in the receiving queue.

4. The meter of claim 2, wherein each of the communication frames comprises a frame identifier, a frame type, a frame source address, and a frame destination address, the frame identifier identifies each communication frame, the frame type indicates a type of each communication frame is a request frame or a response frame, the frame source address indicates an address of a device generating each communication frame, and the frame destination address indicates an address of a destination device of each communication frame.

5. The meter of claim 4, wherein each communication frame and a response frame of each communication frame have the same frame identifier, wherein frame types of each communication frame and the response frame of each communication frame are respectively a request frame and a response frame, wherein the frame source address and the frame destination address of each communication frame are respectively the same as the frame destination address and the frame source address of the response frame of each communication frame.

6. The meter of claim 5, wherein the frame determination module determines whether a frame destination address of the new communication frame is an address of the meter so as to check whether the new communication frame is used to read power consumption of the meter, determines that the new communication frame is used to read power consumption of the meter upon the condition that the frame destination address of the new communication frame is the address of the meter, and determines that the new communication frame is not used to read power consumption of the meter upon the condition that the frame destination address of the new communication frame is not the address of the meter.

7. The meter of claim 1, wherein the communication module further waits a first back-off time according to a collision back-off algorithm until a channel of the power line is idle, and broadcasts the response frame of the new communication frame to the concentrator by the channel of the power line.

8. The meter of claim 5, wherein the frame determination module further determines whether a type of the new communication frame is a request frame.

9. The meter of claim 8, wherein the communication module further waits a second back-off time according to the collision back-off algorithm until the channel of the power line is idle upon the condition that the type of the new communication frame is not a request frame, and broadcasts the new communication frame to the concentrator by the channel of the power line.

10. The meter of claim 8, wherein the communication module further determines whether a response frame of the new communication frame is found in the receiving queue upon the condition that the type of the new communication frame is a request frame, waits a third back-off time according to the collision back-off algorithm until the channel of the power line is idle, and broadcasts the new communication frame to the at least one other meter by the channel of the power line.

11. A communication relay method of a meter, the meter connected to a concentrator and at least one other meter via a power line, the concentrator broadcasting a plurality of request frame to the meter and the at least one other meter via the power line, the meter and the at least one other meter broadcasting a plurality of response frames of the request frames to the concentrator via the power line to read power consumption of the meter and the at least one other meter, the communication relay method comprising:
receiving a new communication frame from the power line, wherein the new communication frame is one of the request frames and the response frames;
determining whether the new communication frame is used to read power consumption of the meter;
generating a response frame of the new communication frame and broadcasting the response frame of the new communication frame to the concentrator via the power line to report the power consumption of the meter if the new communication frame is used to read power consumption of the meter; and
broadcasting the new communication frame to the concentrator and the at least one other meter via the power line if the new communication frame is not used to read power consumption of the meter.

12. The communication relay method of claim 11, wherein the meter stores a receiving queue and a sending queue, the receiving queue is operable to record communication frames received by the meter, and the sending queue is operable to record communication frames sent by the meter.

13. The communication relay method of claim 12, further comprising:
determining whether a frame the same as the new communication frame is found in the receiving queue;
adding the new communication to the receiving queue if no frame the same as the new communication frame is found in the receiving queue; and
ignoring the new communication frame if a frame the same as the new communication frame is found in the receiving queue.

14. The communication relay method of claim 12, wherein each of the communication frames comprises a frame identifier, a frame type, a frame source address, and a frame destination address, the frame identifier identifies each communication frame, the frame type indicates a type of each communication frame is a request frame or a response frame, the frame source address indicates an address of a device generating each communication frame, and the frame destination address indicates an address of a destination device of each communication frame.

15. The communication relay method of claim 14, wherein each communication frame and a response frame of each communication frame have the same frame identifier, wherein frame types of each communication frame and the response frame of each communication frame are respectively a request frame and a response frame, wherein the frame source address and the frame destination address of each communication frame are respectively the same as the frame destination address and the frame source address of the response frame of the communication frame.

16. The communication relay method of claim 15, wherein the step of determining whether the new communication frame is used to read power consumption of the meter comprises:
determining whether a frame destination address of the new communication frame is an address of the meter so as to check whether the new communication frame is used to read power consumption of the meter;
determining that the new communication frame is used to read power consumption of the meter if the frame destination address of the new communication frame is the address of the meter; and
determining that the new communication frame is not used to read power consumption of the meter if the frame destination address of the new communication frame is not the address of the meter.

17. The communication relay method of claim 15, wherein the step of broadcasting the response frame of the new communication frame to the concentrator via the power line to report the power consumption of the meter comprises:
waiting a first back-off time according to a collision back-off algorithm;
determining whether a channel of the power line is idle; and
adding the response frame of the new communication frame to the sending queue; and
broadcasting the response frame of the new communication frame to the concentrator by the channel of the power line if the channel of the power line is idle.

18. The communication relay method of claim 15, wherein the step of broadcasting the new communication frame to the at least one other meter and the concentrator via the power line comprises:
determining whether a type of the new communication frame is a request frame;
waiting a second back-off time according to the collision back-off algorithm if the type of the new communication frame is not a request frame;
determining whether the channel of the power line is idle; and
adding the new communication frame to the sending queue; and
broadcasting the new communication frame to the concentrator via the channel of the power line if the channel of the power line is idle.

19. The communication relay method of claim 18, wherein the step of broadcasting the new communication frame to the at least one other meter and the concentrator via the power line further comprises:
determining whether a response frame of the new communication frame is found in the receiving queue if the type of the new communication frame is a request frame;
calculating a third back-off time according to the collision back-off algorithm;
determining whether the third back-off time arrives if the response frame of the new communication frame is not found in the receiving queue;
continuing to determine whether the response frame of the new communication frame is found in the receiving queue if the third back-off time has not arrived;
determining whether the channel of the power line is idle if the third back-off time has arrived; and
adding the response frame of the new communication frame to the sending queue; and
broadcasting the new communication frame to the at least one other meter by the channel of the power line if the channel of the power line is idle.
